(19) United States
(12) Patent Application Publication
(10) Pub. No.: US 2002/0080332 A1
(43) Pub. Date: Jun. 27, 2002

(54) Projection system and method for positioning objects on a work surface

(76) Inventors: David B. Jones, Carnegie, PA (US); Michael P. Krisky, Glenshaw, PA (US)

Correspondence Address: KIRKPATRICK & LOCKHART LLP, 535 SMITHFIELD STREET, PITTSBURGH, PA, 15222, US

(21) Appl. No.: 10/029,432

(22) Filed: Dec. 19, 2001

Related U.S. Application Data
(60) Provisional application No. 60/259,614, filed on Dec. 21, 2000.

(51) Int. Cl. G03B 21/26

(52) U.S. Cl. 353/28

(57) ABSTRACT

The present invention is directed to a projection system that includes a projector that is capable of displaying an image, a work surface on which the image is displayed, and an object that corresponds to the image for placement substantially in the position of the image on the work surface. The object may be positioned on the work surface by projecting the image on the work surface, and placing the object corresponding to the image substantially in the position of the image on the work surface.

### CROSS-REFERENCE TO RELATED APPLICATIONS

This application claims the benefit of provisional U.S. patent application Ser. No. 60/259,614, filed Dec. 21, 2000.

### BACKGROUND

1. Technical Field

The present invention relates to a projection system and associated method for positioning objects on a work surface.

2. Background

Various industries are in the business of preparing custom or personalized products based on customer specifications. This process includes manufacturing a product having objects such as names, dates, letters, numbers, drilled openings, attachments, emblems, and other insignia in a certain and specific arrangement on the product, as ordered by the customer, to form a finished personalized product. One industry that employs this technique is the specialized metals industry, such as the memorial industry, where significant time and effort are invested to manufacture specialized plaques, memorials, artwork, crypts, and other individualized products based on specific customer orders. Because each order is typically directed to only one customer, manufacturing errors in the placement of these objects on the work surface typically result in the product having to be scraped, and the customer's order re-processed.

The current system of communicating order specifications relies on a written document that is used as a reference by the technician to complete the customer's order. In the memorial industry, for example, the expected spelling of the names and dates, and the existence of emblems or openings for vases and lamps are specified on the order document. It is difficult to mentally visualize the finished appearance of the metal work surface, such as a crypt front, to ensure that all of the objects fit properly. Often, problems with installation and placement of the objects are only noticeable after the product is assembled and installed.

In the prior art systems, the information is read from the written order and is used as a reference while manually positioning all the objects on the product to reflect what is printed on the written order. This manual step is time consuming and has considerable room for error. This is particularly the case when some or all of the order is in a language that is foreign to the technician, or specifies unfamiliar indicia or insignia.

It is especially difficult to properly align and space the characters evenly. Improperly spaced characters can “fall-apart” to appear to be two separate words (as in LAWYER). Characters spaced too far apart can interfere with other objects and components placed on the product, such as flower vases, emblems, and the like. Characters spaced too tightly can appear cramped and unattractive. Character spacing differences is even more noticeable when several products are viewed side-by-side, such as in a row of crypt fronts. The difficulties in character positioning is lessened by the skill of technicians with a high degree of training that has developed a good “eye” and understanding of the principles of “kerning” (i.e. character spacing). However, even skilled technicians may differ on the proper spacing between characters.

In addition, it is surprisingly easy to misspell the information that is placed on the work surface. Although, in some circumstances, letter substitution or correction of the letter position may be possible, the residue glue can result in an undesirable final appearance. A much more difficult situation develops if the work surface, such as a crypt front, has been incorrectly drilled for placement of vases or lamps. In that case, the entire front may be ruined.

Thus, there is a continued need to improve the manner in which objects such as letters, numbers, emblems, insignia, openings, and other components are properly positioned on a work surface to satisfy customer orders that allow for improvements in the manufacture and appearance of finished products.

### BRIEF DESCRIPTION OF THE DRAWINGS

The foregoing summary, as well as the following detailed description of the preferred embodiments, will be better understood when read in conjunction with the appended drawings. In the drawings:

FIG. 1 is a view of one embodiment illustrating the projection system and method according to the present invention;

FIG. 2 is a side elevational view illustrating the projection system and method of FIG. 1;

FIG. 3 is a view of a second embodiment illustrating the projection system and method according to the present invention; and

FIG. 4 is an expanded view of a portion of FIG. 1 illustrating one method of positioning the object on the work surface.

### SUMMARY

In one embodiment of the present invention, a projection system is provided that includes a projector that is capable of displaying an image, a work surface on which the image is displayed, and an object that corresponds to the image for placement substantially in the position of the image on the work surface.

In another embodiment of the present invention, a projection system is provided, and includes a projector that is capable of projecting an image, a computer that is in operative engagement with the projector and has access to the image, a work surface on which the image is displayed, the image being projected substantially perpendicular to the work surface, and an object that corresponds to the image for placement substantially in the position of the image on the work surface.

The present invention also provides a method of positioning an object on a work surface that includes projecting an image on the work surface, and placing the object corresponding to the image substantially in the position of the image on the work surface.

It should be understood that this invention is not limited to the embodiments disclosed in this Summary, but it is intended to cover modifications that are within the spirit and scope of the invention, as defined by the appended claims.

### DETAILED DESCRIPTION OF THE PREFERRED EMBODIMENTS

It is to be understood that certain descriptions of the present invention have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. For example, as discussed herein, the projection system of the present invention may be employed, for example, with various computer systems and other visual aid equipment, and the like. Computer systems and other visual aid equipment are understood by those of ordinary skill in the art, and, accordingly, are not described in detail herein.

Furthermore, embodiments of the present invention will be generally described in the form of a projection system that may be employed to position objects, such as letters, numbers, emblems, scrolls, insignia and other components such as drilled openings, and openings for vases and lamps, on a work surface, such as a crypt front. It will be understood, however, that the present invention may be embodied in forms and applied to end uses that are not specifically and expressly described herein. Furthermore, although particular discussion is directed to placement of objects on a crypt front, one skilled in the art will appreciate that the present invention may be employed in positioning systems other than crypt front positioning systems.

Other than in the operating examples, or unless otherwise expressly specified, all of the numerical ranges, amounts, values, and others in the following portion of the specification may be read as if prefaced by the word “about” even though the term “about” may not expressly appear with the value, amount, or range. Accordingly, unless indicated to the contrary, the numerical parameters set forth in the following specification and attached claims, if applicable, are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

In general terms, the present invention is a projection system and associated method that provides a graphic representation of individual specialty orders through an object positioning process. The system provides a picture of each specialty order on a work surface and may include the text for customer approval, for use as a scaled drawing for technician installation. In one embodiment of the present invention, described herein, the projection allows the technician to actually see what the finished specialty product will look like on the work surface before it is physically produced. The present invention employs a projection of the customer order on a work surface that may be employed as a guide to position objects thereon.

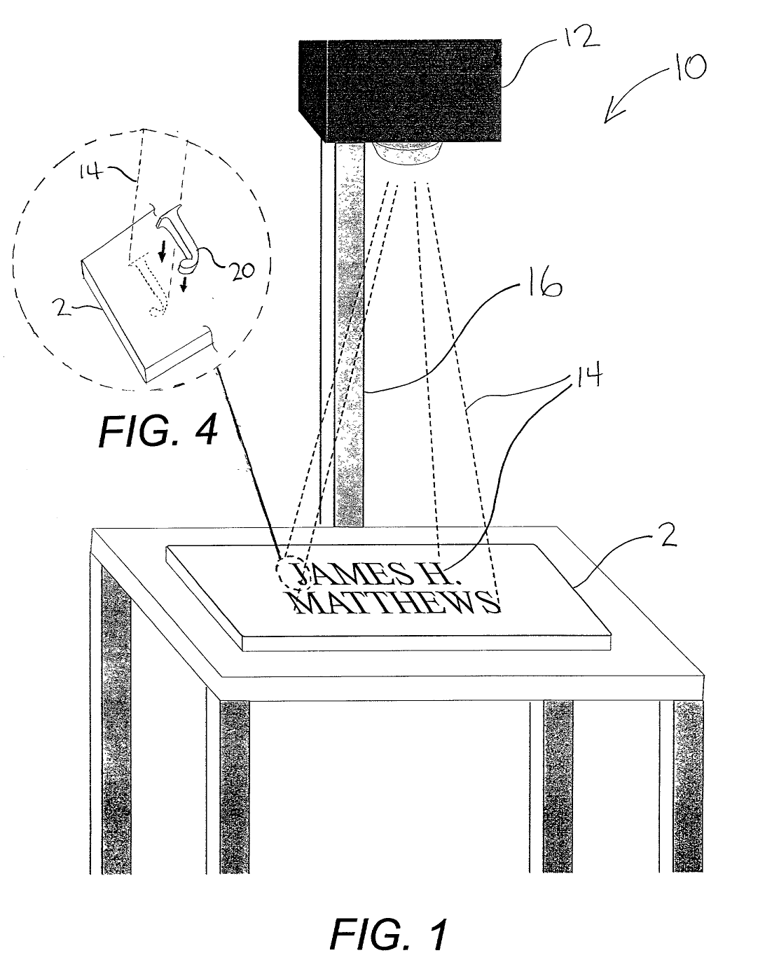

As set forth in FIGS. 1-4, the projection system 10 and associated method of the present invention, generally, includes a projector 12 for projecting an image 14, and a work surface 2 on which the image 14 is projected. The projected image 14 acts as a guide or a marker such that an object 20 that corresponds to the image 14 may be positioned substantially in the position of the image 14 on the work surface 2.

The work surface 2 of the present invention may be any work surface that receives specially placed objects 20 thereon, but is typically a metal work surface, and includes, for example, fronts of memorials, plaques, crypts, and other artwork. When the work surface 2 is a metal work surface, any type of metal or metal alloy that is known in the specialized metal industry may be employed, such as, for example, bronze, copper, tin, aluminum, stainless steel, and the like.

On the work surface 2 is placed objects 20 that are to be positioned thereon, and which are typically attachment thereto, usually by adhesion, to form the specialty product. The objects 20 contemplated by the present invention are any components that are typically employed in the specialty fabrication industry, such as those that are employed to manufacture specialty metal products. As used herein, the term “object” is meant to include any component that may be positioned on the work surface 2, and includes, but is not limited to, indicia, such as names, dates, letters, numbers, and special characters; insignia, such as emblems and scrolls; openings, such as drilled openings and openings for attachments, such as vases and lamps; and etchings and cuttings. When the work surface 2 is a metal work surface, the indicia and insignia are typically formed of the same or similar metal or metal alloy as the metal or metal alloy that comprises the work surface 2. The objects 20 are placed in a specific arrangement on the work surface 2, as identified by the work order, to form a finished personalized product.

The projector 12 may be any conventional projector that suitably projects an image onto the work surface 2. Typically the projector 12 is a multimedia projector that has good imaging capabilities, with little or no distortion, and is compatible with a computer that reads scanned and scaled images and can operate visual basic software. Suitable projectors are those commercially available and identified as Proxima projectors, such as the Proxima Desktop Projector 9260+, manufactured by InFocus Corporation, Wilsonville, Oreg.

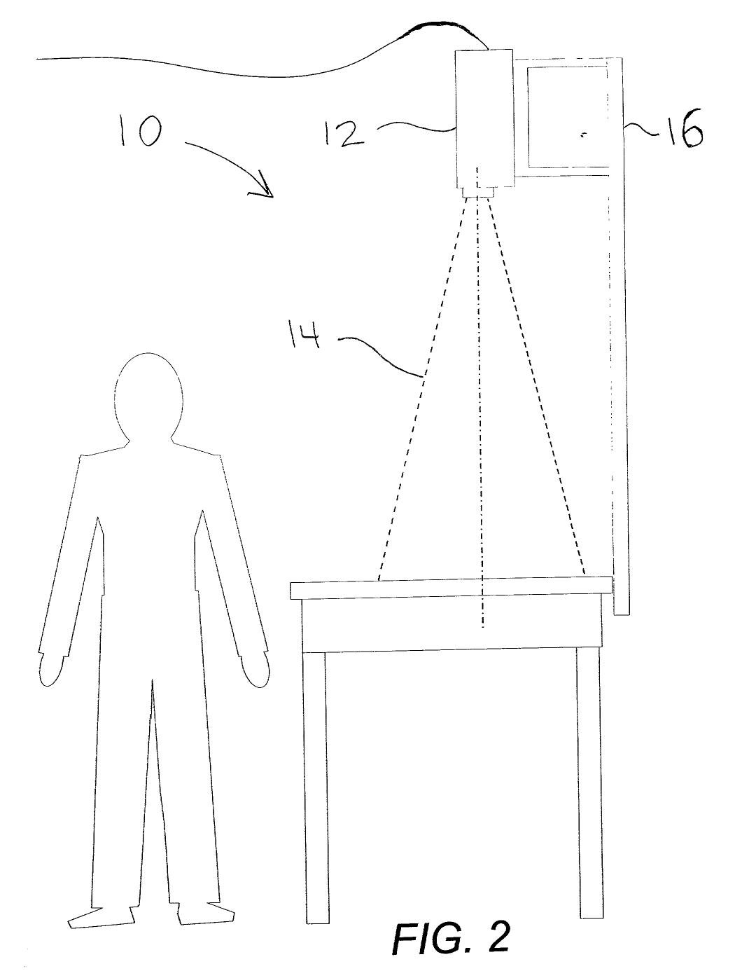

A mounting system 16, such as a projection stand, may be employed to securely position the projector 12 at a suitable and appropriate height and at a predetermined distance from the work surface 2. The projector 12 may be positioned at any suitable height from the work surface 2 to provide acceptable imaging results, and is dependent, for example, on the projector used, the projector lens employed, and the positioning between it and the work surface 2. For example, in the embodiment illustrated in FIGS. 1 and 2, it has been found that a Proxima Desktop Projector 9260+ projector positioned directly overhead of a crypt front work surface 2 may be positioned 120 to 135 inches, typically about 124 inches, (as measured from the projector lens) from the work surface 2 in order to provide acceptable imaging results. In addition to simple manual adjustment of the projector 12 for proper placement of the projector 12 relative to the work surface 2, various databases that are generally known and commercially available (see, for example, Internet URL www.proxima.com, or particularly, www.proxima.com/site/products/PRproicaIc.cfm, incorporated herein by reference in their entirety) provide calculations based on various factors, such as projector type, width, and distance, that allow the technician to determine proper projector placement relative to the work surface 2.

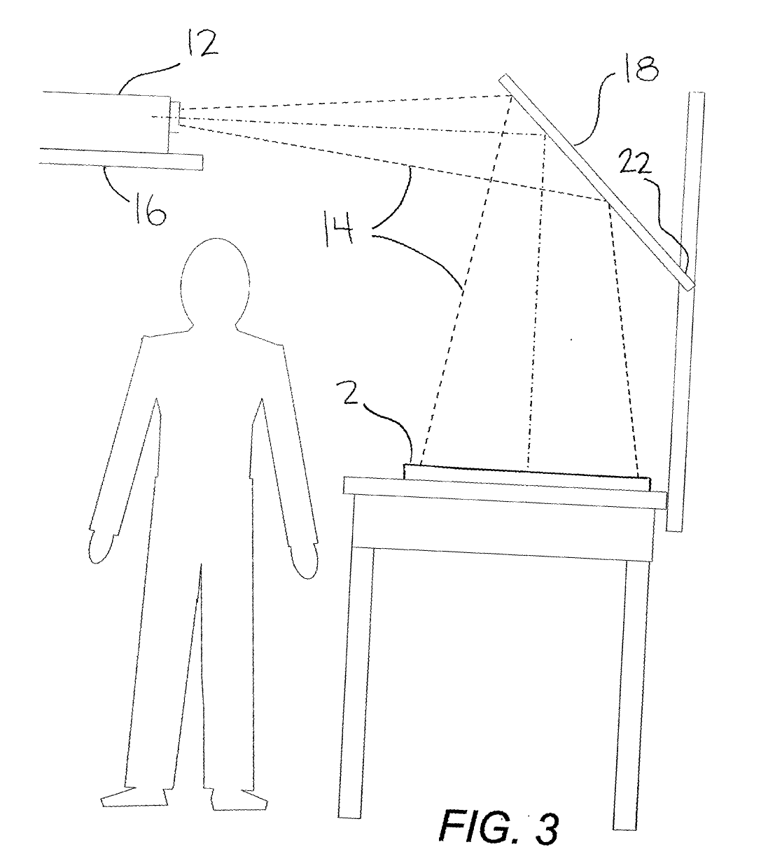

As shown in FIGS. 1 and 2, the projector 12 may be positioned directly above the work surface such that the image 14 is projected in a direction substantially perpendicular to the work surface 2, in order to obtain a clear and undistorted image on the work surface 2. In another embodiment, shown in FIG. 3, the projector 12 may be positioned such that the image 14 is projected in a direction substantially parallel to the work surface 2. In this latter embodiment, a mirror 18, described below, is employed to reflect the image 14 in a direction substantially perpendicular to the work surface 2.

The projector 12 may be positioned at a distance and in a manner from the work surface 2 that allows the image 14 to correspond to the object 20 that is to be positioned on the work surface 2. As used herein, the term “correspond” generally refers to a projected image 14 that acts as a guide or marker on the work surface 2 for positioning and permanent placement of the object 20. Typically, the image 14 is projected to provide a clear, square, full, and undistorted (i.e. “true”) image of the object 20 on the work surface 2. For example, the projected image 14 may be projected on the work surface 2 at a size and shape that is similar to, and, typically, substantially equal to the size and shape of the object 20.

The projected image 14 may be derived from any suitable form that allows it to be projected from the projector 12 and onto the work surface 2. The image 14, for example, may be derived from a conventional transparency or slide that is transferred from the projector 12 onto the work surface 2. Typically, however, the image 14 is a scanned and compressed image in a computer database with the aid of suitable computer software. For example, visual basic software such as, for example, CorelDraw®, commercially available from Corel Corporation, Ottawa, Ontario, Canada, may be employed with a suitable computer operating system to transform a written document order into a computer readable form, that acts in association and in operative engagement with the projector 12 to project the image 14 squarely onto the work surface 2.

As illustrated in FIG. 3, the projection system 10 of the present invention may include a mirror 18 to aid in the projection of the image 14 such as, for example, in low headroom environments. The mirror 18 may be used when the projector 12 is not positioned directly overhead, and the image 14 projected therefrom is not substantially perpendicular to the work surface 2. For example, as illustrated in FIG. 3, the projector 12 may be positioned to project the image 14 in a direction substantially parallel to the work surface 2. In this embodiment, such as, for example, when the work surface 2 is a crypt front, the projector 12 may be positioned from the floor at a height substantially equal to the distance from the floor to the bottom of the mirror 18, such as, for example, about 66 inches. Furthermore, the distance between the projector 12 and the bottom of the mirror may be any suitable distance, such as, for example, about 88 inches. It has been found that when a Proxima Desktop Projector 9260+ projector is employed to project the image 14 in a direction substantially parallel to the work surface 2, the total distance from the projector 12 to the bottom of the mirror 18 and the bottom of the mirror 18 to the work surface 2 is 120 to 135 inches, typically about 124 inches, (as measured from the projector lens) to provide acceptable imaging results. Although the mirror 18 may be positioned in any manner and at any angle that reflects a clear, square, full, and undistorted image 14 on the work surface 2, in the embodiment illustrated in FIG. 3, the mirror 18 is positioned at a 45° angle relative to the work surface 2 to reflect the image in a direction substantially perpendicular to the work surface 2. The mirror 18, as illustrated, may be positioned directly above the work surface 2 such that the bottom of the mirror is positioned, for example, at a distance of about 34 inches from the work surface 2, with the work surface 2 positioned about 32 inches from the ground. The mirror 18 may be any commercial grade product, or may be a commercially available optically correct single-sided mirror, such as those manufactured by EMF Corporation, Ithaca, N.Y. The mirror 18 may be any size and shape such as, for example, 48 inches high by 36 inches wide, and may be supported in any manner that securely positions the mirror to reflect the image 14 squarely onto the work surface 2. Suitable positioning systems include, for example, a turnbuckle system 22 (i.e. a system wherein the mirror pivots on a single point), as illustrated, commercially available from McMaster-Carr Supply Company, Chicago, Ill.

As illustrated in FIG. 4, the projected image 14 acts as a guide or marker for placement of the object 20 in substantially the position of the image on the work surface 2. More particularly, the image 14 is projected from the projector 12 onto the work surface 2, as described in detail above. Preferably, the image 14 is projected in a manner that provides a true image 14 on the work surface 2. Thereafter, the object 20 corresponding to the image 14 is placed in substantially the position marked by the image 14 on the work surface 2. When the object 20 is indicia or insignia (i.e. when the object 20 is not a cutting or engraving into the work surface 2), the object 20 may be attached to the work surface 2 in any manner known to those of ordinary skill in the art, such as by gluing. In one embodiment of the present invention, as discussed above and as illustrated, the projector 12 and the work surface 2 are positioned at a distance and in a manner such that the image 14 and corresponding object 20 are similar in size and shape, and, typically, are substantially equal in size and shape.

It is contemplated that the projected image 14 need not identically represent the object 20, but, rather, may simply be a projection of an underlined or boxed portion for alignment and positioning of the object 20 on the work surface 2. The projected image 14 may also be a series of projected markers, such as dots, dashes, or the like, for placement of each object 20. Accordingly, the projected image 14 may be one or more marks that position the object 20 on the work surface 2, and need not be substantially the same size and shape as the object 20. It is also contemplated that the object 20 may be an engraving or cutting into the work surface 2 rather than a physical object, such as indicia or insignia (shown in FIG. 4 and described above, that is attached to the work surface 2), and that the image 14 may act as a marker to the engraving or cutting.

The present invention provides a projected system and associated method that allows objects to be properly positioned on a work surface to satisfy customer orders that improves the manufacture and appearance of finished products. The improved communications and assurance of fit set forth in the present invention reduces errors and provides a guide for standardized character spacing in the final product prior to assembly. Accordingly, post operations, such as line-up and spacing of all components, may be eliminated and straightening operations may be substantially reduced. The present invention also substantially reduces or eliminates the potential for spelling errors and interference between components.

It will also be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

Therefore, we claim:

1. A projection system, comprising:
a projector that is capable of displaying an image;
a work surface on which the image is displayed; and
an object that corresponds to the image for placement in substantially the position of the image on the work surface.

2. The projection system of claim 1, wherein the image is projected in a direction substantially perpendicular to the work surface.

3. The projection system of claim 1, wherein the projector and the work surface are separated by a predetermined distance.

4. The projection system of claim 3, wherein the projector and the work surface are positioned at a distance that allows the image to be projected on the work surface at a size and shape substantially equal to the size and shape of the object.

5. The projection system of claim 4, wherein the work surface is a crypt front.

6. The projection system of claim 1, wherein the image is projected in a direction substantially parallel to the work surface.

7. The projection system of claim 6, further including a mirror to reflect the image in a direction substantially perpendicular to the work surface.

8. The projection system of claim 1, further comprising a computer that is in operative engagement with the projector that has access to the image.

9. The projection system of claim 8, wherein the image is projected in a direction substantially parallel to the work surface, and further including a mirror to reflect the image in a direction substantially perpendicular to the work surface.

10. A projection system, comprising:
a projector that is capable of projecting an image;
a computer that is in operative engagement with the projector and has access to the image;
a work surface on which the image is displayed, the image projected substantially perpendicular to the work surface; and
an object that corresponds to the image for placement substantially in the position of the image on the work surface.

11. The projection system of claim 10, wherein the projector and the work surface are separated by a predetermined distance.

12. The projection system of claim 11, wherein the projector and the work surface are positioned at a distance that allows the image to be projected on the work surface at a size and shape substantially equal to the size and shape of the object.

13. The projection system of claim 10, wherein the work surface is a crypt front.

14. The projection system of claim 10, wherein the image is projected in a direction substantially parallel to the work surface, and further including a mirror positioned to reflect the image in a direction substantially perpendicular to the work surface.

15. A method of positioning an object on a work surface, comprising;
projecting an image on the work surface; and
placing the object corresponding to the image substantially in the position of the image on the work surface.

16. The method of claim 15, wherein the image is projected substantially perpendicular to the work surface.

17. The method of claim 15, wherein the image is projected substantially parallel to the work surface.

18. The method of claim 17, further including a mirror positioned to reflect the image in a direction substantially perpendicular to the work surface.

19. The method of claim 15, further comprising a projector that is operative engagement with a computer that has access to the image.

20. The method of claim 19, wherein the projector and the work surface are positioned at a distance such that the image and corresponding object are substantially equal in size and shape.
